(19) United States
(12) Patent Application Publication
(10) Pub. No.: US 2016/0178869 A1
(43) Pub. Date: Jun. 23, 2016

(54) Devices and Methods for Positioning a Camera Lens with Magnetostrictive Elements

(71) Applicant: Facebook, Inc., Menlo Park, CA (US)

(72) Inventor: Shizhe Shen, San Mateo, CA (US)

(21) Appl. No.: 14/580,033

(22) Filed: Dec. 22, 2014

(51) Int. Cl. G02B 13/00; H04N 5/232; H04N 5/225; G03B 13/36; G02B 27/64

(52) U.S. Cl. CPC G02B 13/0015; G03B 13/36; G02B 27/646; H04N 5/2254; H04N 5/23212

(57) ABSTRACT

A camera lens actuator unit includes a first lens group that includes at least one lens; a second lens group that includes at least one lens; an inner lens element configured to move along an optic axis between the first lens group and the second lens group; one or more magnetostrictive elements coupled to the inner lens element; and at least one voice coil. An image is focused on a digital image sensor by moving the inner lens element along the optic axis between the first lens group and the second lens group. The one or more magnetostrictive elements move the inner lens element along the optic axis in response to a current applied to the at least one voice coil.

### TECHNICAL FIELD

This relates generally to optical lenses, including but not limited to imaging lenses for autofocus cameras.

### BACKGROUND

Autofocus imaging lenses offer fast and simple focusing for cameras and other optical devices. Image stabilization systems in imaging lenses reduce the effects of camera shake, enabling users to capture sharp images and avoid image blur caused by unsteady hands. Both autofocus and optical image stabilization use precisely controlled movements of lenses or lens elements in order to achieve the desired optical results (e.g., in-focus images without shake-induced image blur). For example, autofocus systems move one or more lenses towards or away from an image plane along an optic axis in order to bring the image into focus, and optical image stabilization systems move one or more lenses away from an optic axis (e.g., by translating or tilting the one or more lenses) in order to compensate for shaking of the imaging device.

As imaging lenses are further miniaturized, for use in smart phones, for example, existing mechanisms for moving lenses to provide autofocus and optical imaging stabilization are too slow, too inaccurate, and require too much power.

### SUMMARY

Accordingly, there is a need for autofocus and optical image stabilization systems and methods that are faster, more accurate, and consume less power. Such systems and methods optionally complement or replace conventional methods for autofocus and optical image stabilization.

In accordance with some embodiments, a camera lens actuator unit includes a first lens group that includes at least one lens, a second lens group that includes at least one lens, an inner lens element configured to move along an optic axis between the first lens group and the second lens group, one or more magnetostrictive elements coupled to the inner lens element, and at least one voice coil. An image is focused on a digital image sensor by moving the inner lens element along the optic axis between the first lens group and the second lens group. The one or more magnetostrictive elements move the inner lens element along the optic axis in response to a current (or voltage) applied to the at least one voice coil.

In accordance with some embodiments, a method is performed at a camera lens actuator unit. The camera lens actuator unit includes a first lens group that includes at least one lens, a second lens group that includes at least one lens, an inner lens element configured to move along an optic axis between the first lens group and the second lens group, one or more magnetostrictive elements coupled to the inner lens element, and at least one voice coil actuator. The method includes applying a current (or voltage) to the at least one voice coil actuator, and, in response to applying the current to the at least one voice coil actuator, moving the inner lens element with the one or more magnetostrictive elements along an optic axis to focus an image on a digital image sensor.

In accordance with some embodiments, a camera lens actuator unit includes a plurality of lenses, including a first lens element, a plurality of magnetostrictive elements coupled to the first lens element, and a plurality of voice coils. A respective voice coil is configured to strain a corresponding magnetostrictive element in the plurality of magnetostrictive elements coupled to the first lens element. An image is focused on a digital image sensor by moving at least some of the plurality of lenses along an optic axis of the camera lens actuator unit. To stabilize the image, a respective magnetostrictive element moves the first lens element away from the optic axis in response to a current applied to a corresponding voice coil for the respective magnetostrictive element.

In accordance with some embodiments, a method is performed at a camera lens actuator unit. The camera lens actuator unit includes a plurality of lenses, including a first lens element, a plurality of magnetostrictive elements coupled to the first lens element, and a plurality of voice coils, wherein a respective voice coil is configured to strain a corresponding magnetostrictive element in the plurality of magnetostrictive elements coupled to the first lens element. The method includes focusing an image on a digital image sensor by moving at least some of the plurality of lenses along an optic axis of the camera lens actuator unit, and stabilizing the image by moving, with a respective magnetostrictive element, the first lens element away from the optic axis in response to a current applied to a corresponding voice coil for the respective magnetostrictive element.

Thus, autofocus and optical image stabilization systems and methods are provided that are faster, more accurate, and consume less power. Such methods and systems optionally complement or replace conventional methods for autofocus and optical image stabilization.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a cross-section of a lens actuator unit in accordance with some embodiments.

FIGS. 2A-2M are diagrams illustrating various aspects of a lens actuator unit in accordance with some embodiments.

FIG. 3 is a block diagram illustrating an imaging system in accordance with some embodiments.

FIG. 4 is a flow diagram illustrating a method of focusing an image in accordance with some embodiments.

FIG. 5 is a flow diagram illustrating a method of stabilizing an image in accordance with some embodiments.

### DESCRIPTION OF EMBODIMENTS

Systems and methods for using magnetostrictive materials to provide autofocus and optical image stabilization are disclosed. Magnetostrictive materials are materials that change their shape or dimensions when subjected to a magnetic field. In the disclosed embodiments, magnetostrictive materials are employed in lens actuator units to cause appropriate movements of lenses to achieve various outcomes, such as focusing an image, compensating for camera shake, or the like. Voice coils, or other means for producing magnetic fields, are disposed in or near the lens actuator unit in proximity to the magnetostrictive materials in order to produce and control magnetic fields. Movement of lenses, including, for example, the speed and magnitude of the movement, is controlled by controlling the voltage and/or current applied to the voice coil. In particular, the magnitude of a strain induced in a magnetostrictive material is related to the magnitude of the magnetic field to which the magnetostrictive material is subjected. Thus, by applying a magnetic field of a particular magnitude, a particular strain can be induced in the magnetostrictive material. Voice coils thereby actuate the magnetostrictive materials, and therefore may also be referred to as voice coil actuators.

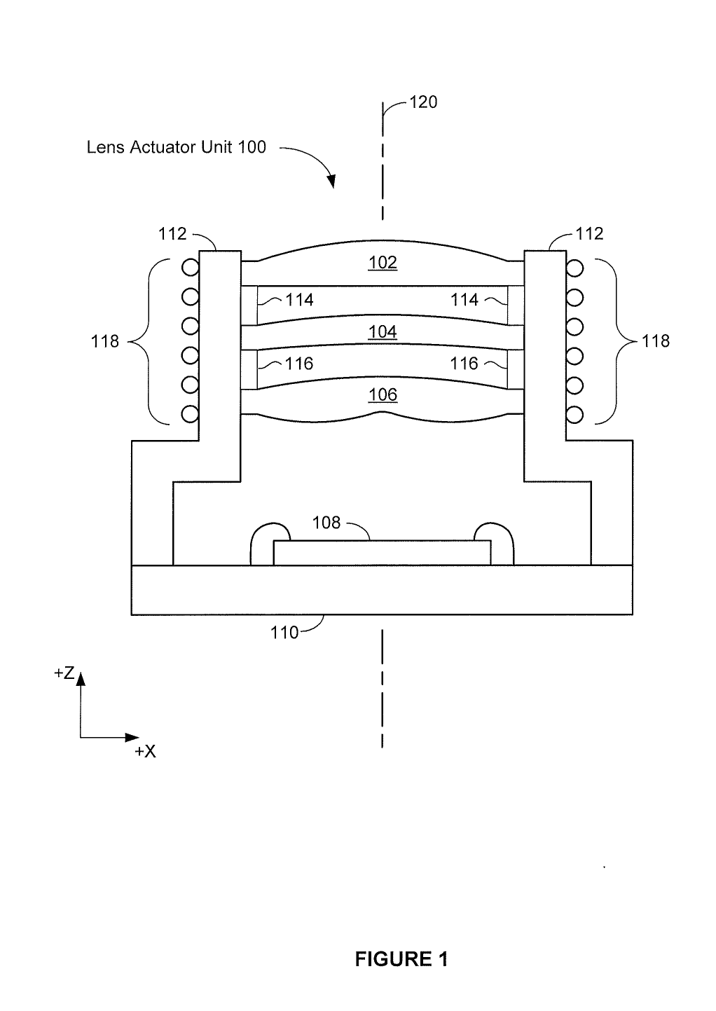

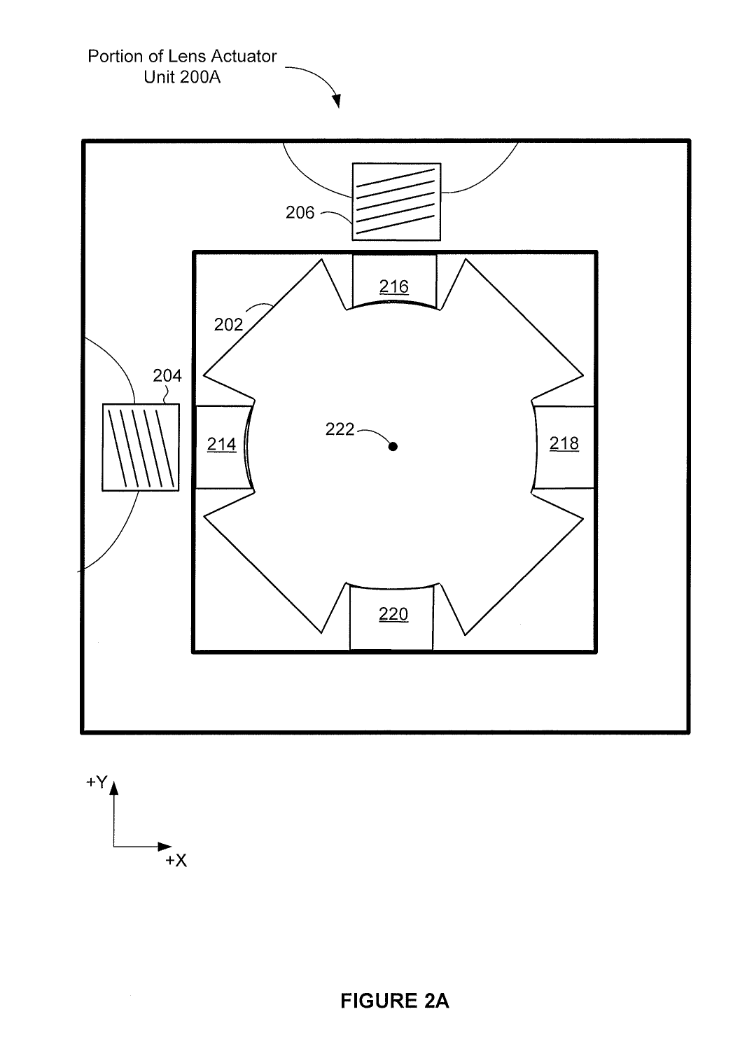

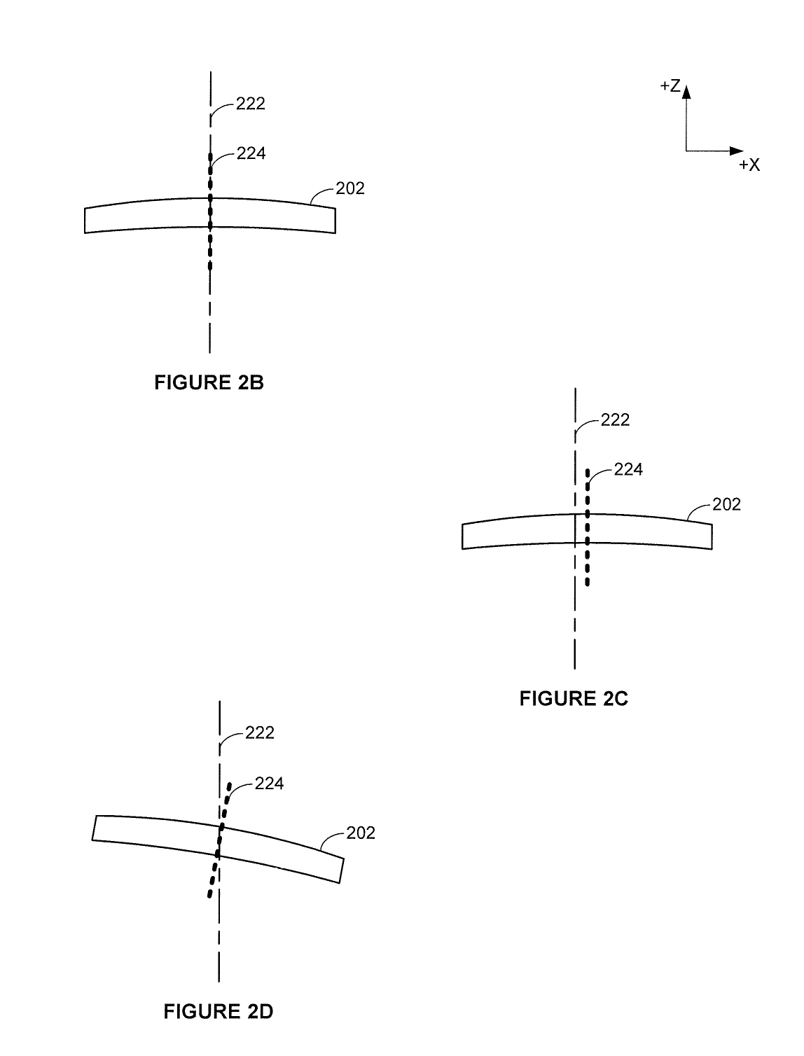

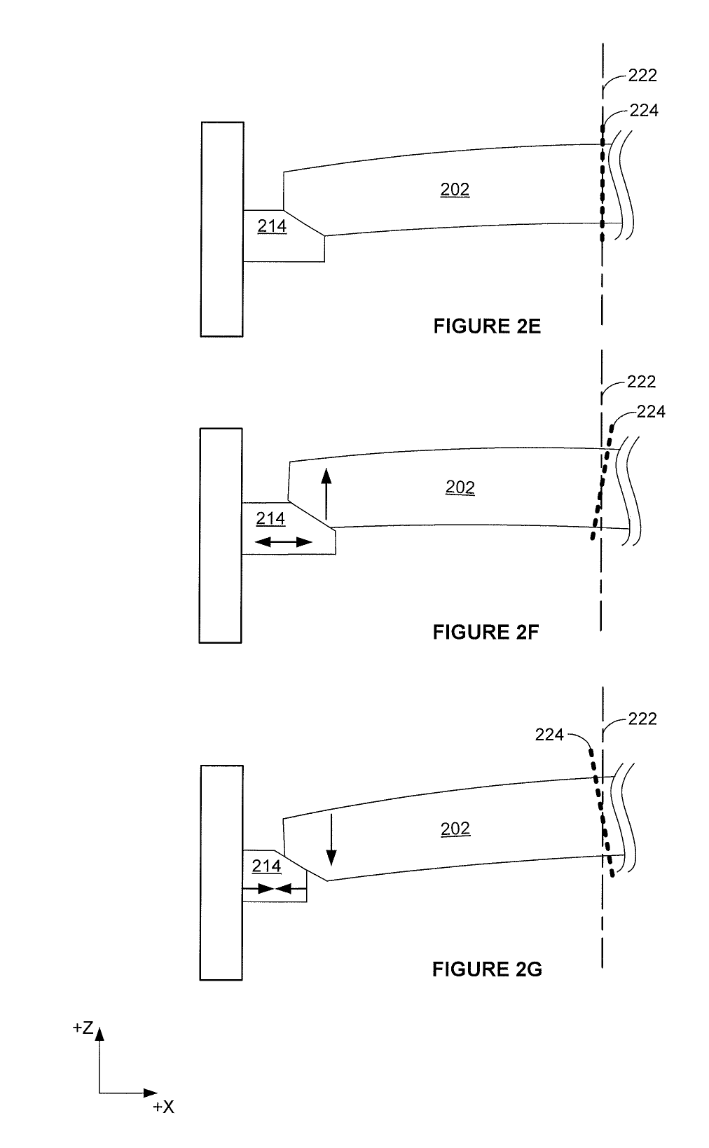

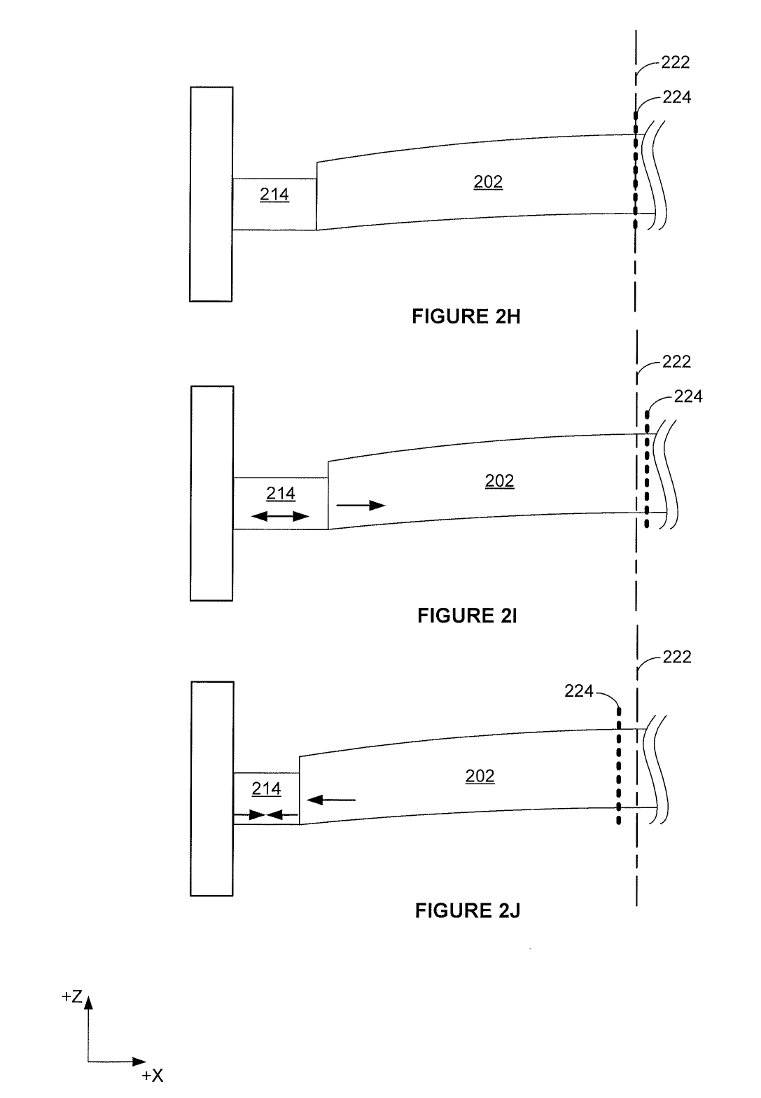

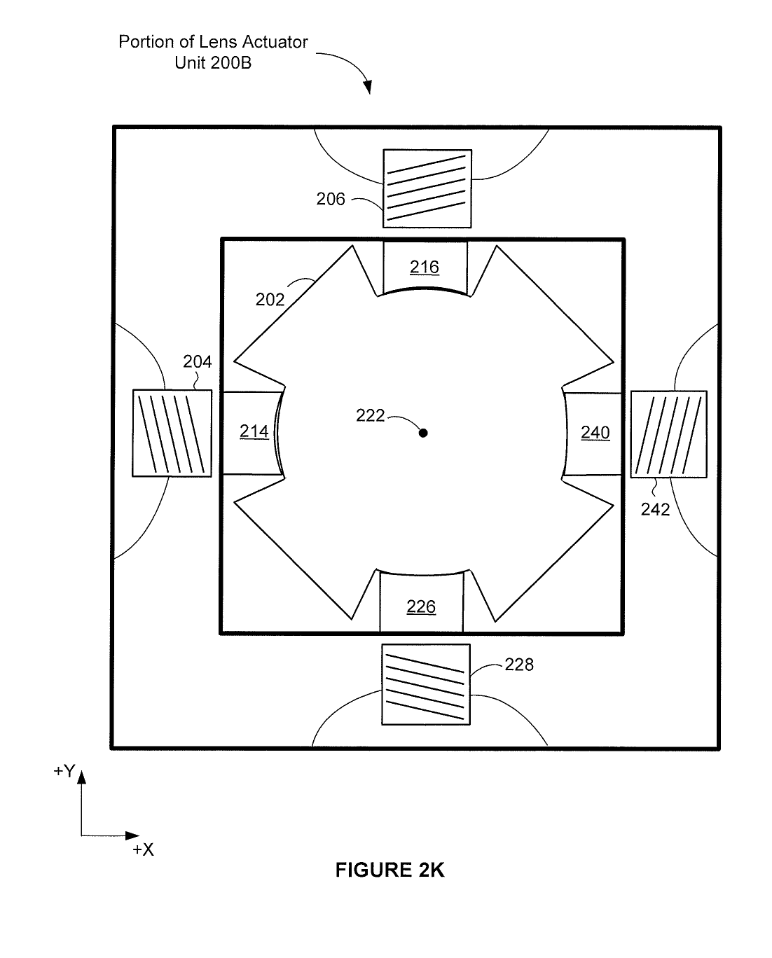

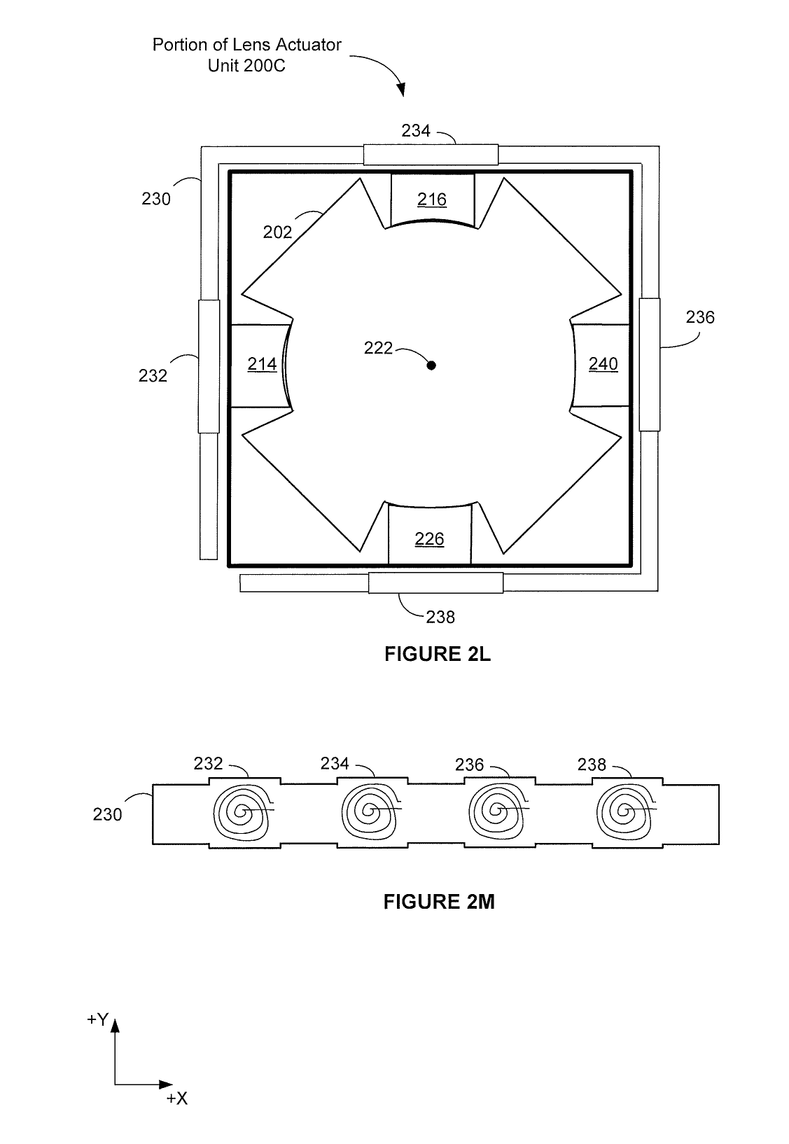

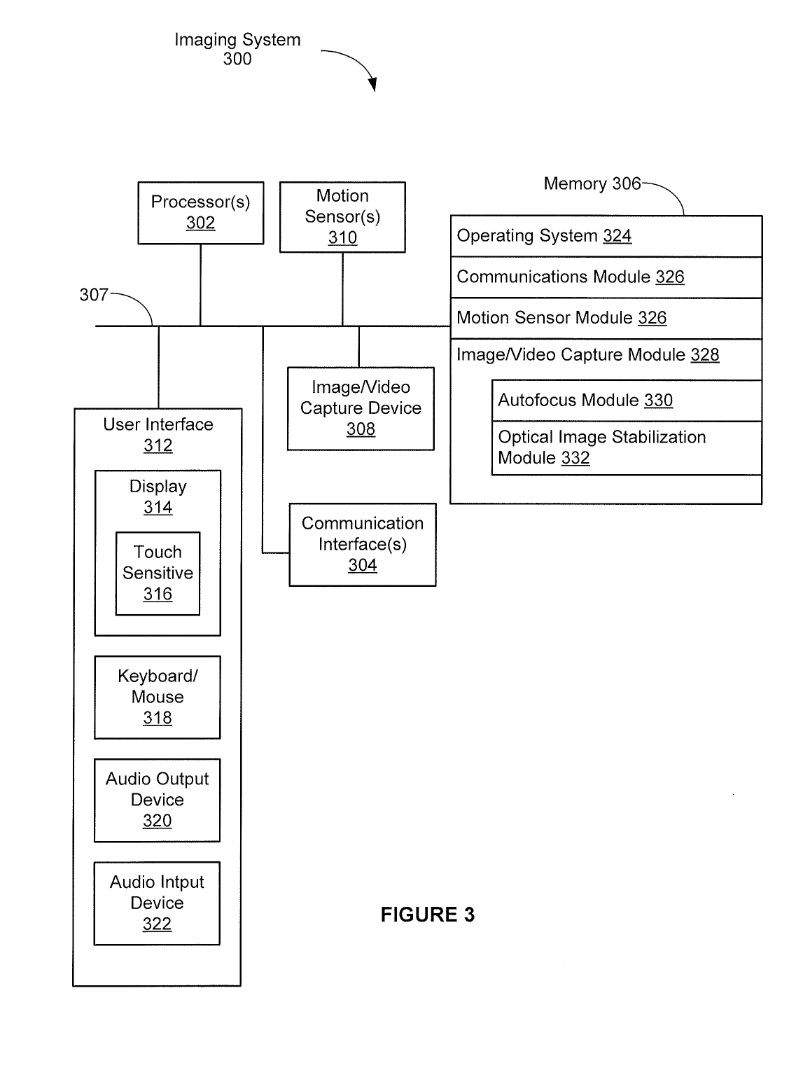

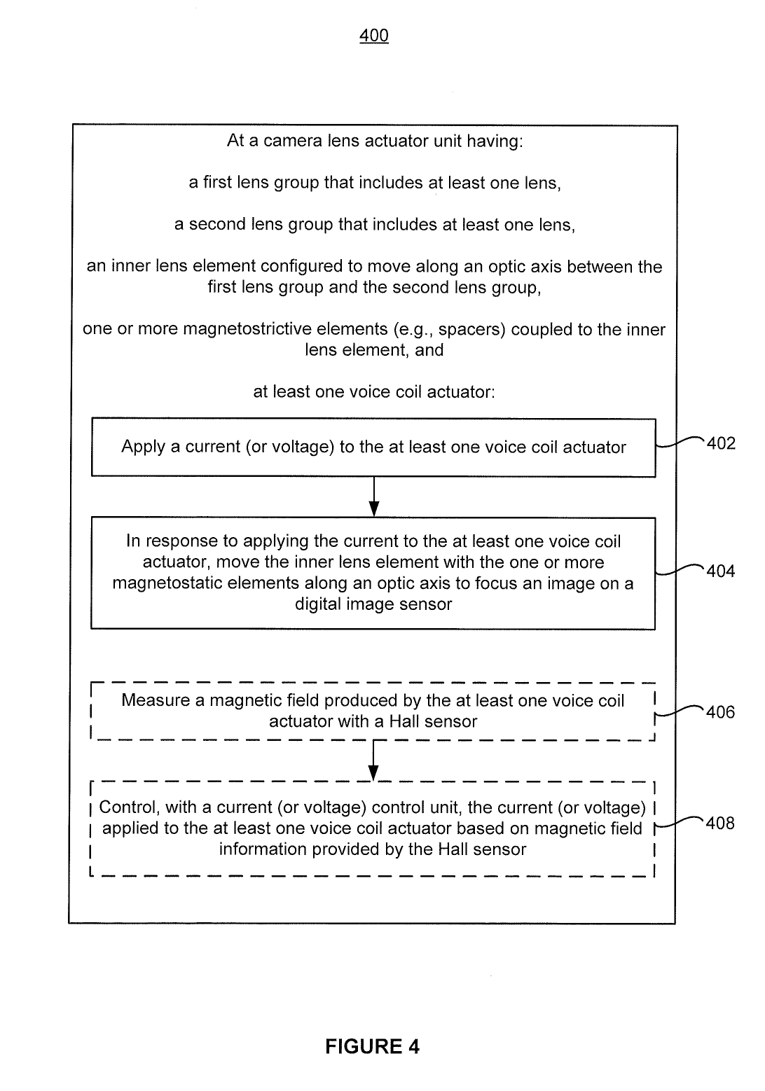

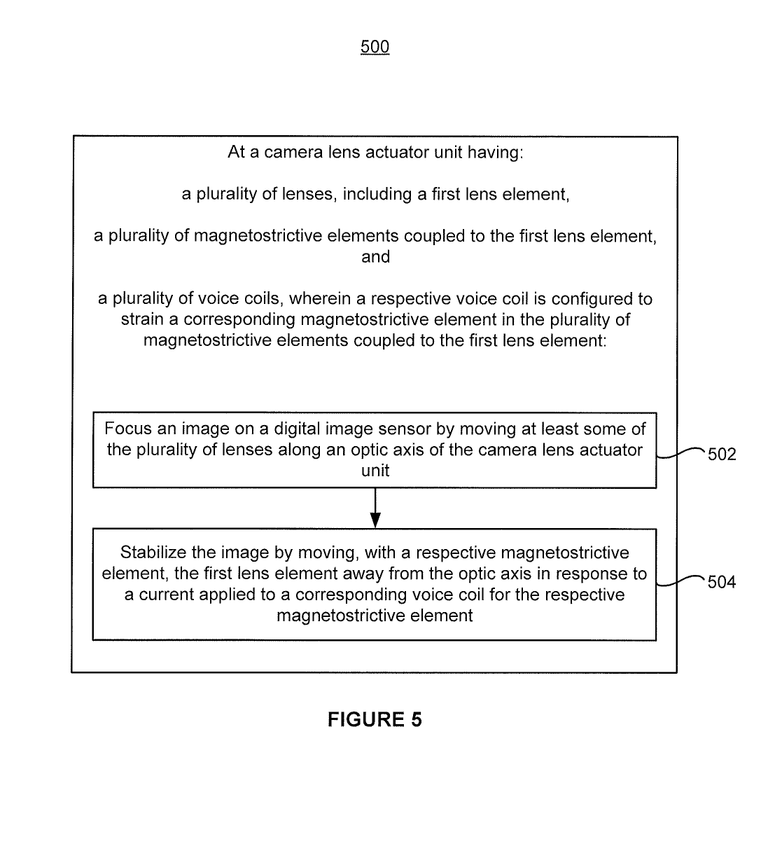

Below, FIG. 1 illustrates a lens actuator unit using magnetostrictive materials for focusing an image, according to some embodiments. FIGS. 2A-2M illustrate a lens actuator unit using magnetostrictive materials for providing optical image stabilization, according to some embodiments. FIG. 3 is an imaging system in which lens assemblies using magnetostrictive materials for focusing and/or optical image stabilization may be used. FIG. 4 is a flow diagram illustrating a method of focusing an image. FIG. 5 is a flow diagram illustrating a method of optical image stabilization.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first lens could be termed a second lens, and, similarly, a second lens could be termed a first lens, without departing from the scope of the various described embodiments. The first lens and the second lens are both lenses, but they are not the same lens.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

FIG. 1 illustrates a cross-section of a lens actuator unit 100 employing magnetostrictive materials, according to some embodiments. The lens actuator unit 100 (also referred to as a “lens unit” 100) includes a first lens group that includes at least one lens (e.g., a first lens 102), a second lens group that includes at least one lens (e.g., a second lens 106), and an inner lens element that includes at least one lens (e.g., inner lens 104). The lenses 102, 104, and 106 are concentrically aligned along an optic axis 120. As described herein, the inner lens 104 is configured to move along the optic axis between the first lens group and the second lens group.

For simplicity, the lens unit 100 is shown with three individual lenses. However, other lens configurations are also contemplated, including lens units with additional lenses, and lens units having lens groups that contain multiple lenses. For example, in some embodiments, the first lens group includes one or more additional lenses in addition to the first lens 102. In some embodiments, the inner lens element is a lens group that includes multiple lenses (as opposed to a single inner lens 104) that are configured to move along the optic axis between the first lens group and the second lens group.

The lens unit 100 includes one or more magnetostrictive elements coupled to the inner lens 104. For example, as shown in FIG. 1, the inner lens 104 is separated from the first lens 102 by a resilient spacer 114. The resilient spacer 114 is made of or includes a resilient material, such as an elastomeric polymer, a spring, or any other appropriate material. The inner lens 104 is also separated from the second lens 106 by the magnetostrictive spacer 116, where the magnetostrictive spacer 116 is made of or includes a magnetostrictive material.

In the lens unit 100, the inner lens 104 is moved in a positive or negative z direction along the optic axis 120 as a result of expansion and contraction of the magnetostrictive spacer 116. In particular, applying (or increasing the magnitude of) a magnetic field on the magnetostrictive spacer 116 causes the magnetostrictive spacer 116 to expand, which causes a corresponding movement of the inner lens 104 in the positive z direction. This movement of the inner lens 104 causes the resilient spacer 114 to compress. Upon removal or reduction of the magnetic field, the magnetostrictive spacer 116 contracts, causing a corresponding movement of the inner lens 104 in a negative z direction, and allowing the resilient spacer 114 to expand.

In the present discussion, expansion of the spacers 116 and 114 refers to expansion in the z direction, and contraction of the spacers 116 and 114 refers to contraction in the z direction. When subjected to a magnetic field, the magnetostrictive spacer 116 may expand or contract in other directions as well. For example, when the magnetostrictive spacer 116 expands in the z direction, the magnetostrictive spacer 116 may simultaneously contract in the x direction (or any other direction or dimension). Contraction or expansion in other directions or dimensions, however, does not directly cause movement of the inner lens 104, and thus is not pertinent to the present discussion.

In some embodiments, the materials of the spacers 114 and 116 are swapped, so that the spacer 116 is or includes a resilient material, and the spacer 114 is or includes a magnetostrictive material.

In some embodiments, the spacers 114, 116 are cylindrical. For example, the spacers 114, 116 are shaped like washers, and contact the lenses of the lens unit 100 around a perimeter or outer edge of the lens. In some embodiments, the spacers 114, 116 are any other appropriate shape.

In some embodiments, the spacers 114, 116 are or include one or more pillars (e.g., cubes or rectangular prisms) that contact the lens at discrete areas at a perimeter or outer edge of the lens. For example, instead of a washer-shaped spacer that contacts the lens around the perimeter or outer edge of the lens, a spacer may be composed of 2, 3, 4, or more pillars positioned at regular distances around the perimeter of the lens (e.g., at areas corresponding to 0 degrees, 90 degrees, 180 degrees, and 270 degrees around the perimeter of the lens).

In some embodiments, the one or more magnetostrictive elements (e.g., the magnetostrictive spacer 116) are made of an alloy that includes terbium and iron. In some embodiments, the one or more magnetostrictive elements are made of or include Terfenol-D.

In some embodiments, the inner lens 104 is affixed to the magnetostrictive spacer 116 such that the magnetostrictive spacer 116 imparts motive force on the inner lens 104 in the positive z direction when the magnetostrictive spacer 116 expands and also imparts a motive force on the inner lens 104 in the negative z direction when the magnetostrictive spacer 116 contracts. In other words, the magnetostrictive spacer 116 both pushes and pulls the inner lens 104. In such cases, the inner lens 104 may be bonded (e.g., glued), clipped, or otherwise affixed to the magnetostrictive spacer 116.

Alternatively, in some embodiments, the magnetostrictive spacer 116 only imparts motive force on the inner lens 104 when the magnetostrictive spacer 116 expands. When the magnetostrictive spacer 116 contracts to its original size, the resilient spacer 114 (which had previously compressed in response to the expansion of the magnetostrictive spacer 116) imparts a returning force on the inner lens 104 in the negative z direction. This returning force causes the inner lens 104 to be pressed against the magnetostrictive spacer 116, thus keeping the inner lens 104 in contact with both the magnetostrictive spacer 116 and the resilient spacer 114.

In some embodiments, inner lens 104 is positioned such that either the maximum or minimum focus distance of the lens actuator unit 100 corresponds to the magnetostrictive spacer 116 being fully contracted (e.g., corresponding to the magnetostrictive spacer 116 not being subjected to a magnetic field from the voice coil 118). Thus, where the maximum focus distance of the lens actuator unit 100 corresponds to the magnetostrictive spacer 116 being fully contracted, the minimum focus distance of the lens actuator unit 100 corresponds to the magnetostrictive spacer 116 being fully expanded. On the other hand, where the minimum focus distance of the lens actuator unit 100 corresponds to the magnetostrictive spacer 116 being fully contracted, the maximum focus distance of the lens actuator unit 100 corresponds to the magnetostrictive spacer 116 being fully expanded.

In some embodiments, the lens unit 100 is coupled to a substrate 110 to which a digital image sensor 108 is mounted. In some embodiments, the substrate is a circuit board (e.g., a printed circuit board, a flexible circuit board, etc.).

As described herein, an image is focused on the digital image sensor 108 by moving the inner lens 104 along the optic axis 120 between the first lens group (e.g., the first lens 102) and the second lens group (e.g., the second lens 106).

The digital image sensor 108 is any sensor that converts an optical image into an electronic signal. In some embodiments, the digital image sensor 108 is a charge coupled device (CCD), a complementary metal-oxide-semiconductor (CMOS), an N-type medal-oxide-semiconductor (NMOS), or any other appropriate type of sensor. In some embodiments, the lens units and methods described herein are used in conjunction with an analog image-sensing medium, such as photographic film.

The lens unit 100 includes a mounting structure 112 that supports the lenses (and/or other components of the lens unit 100). In some embodiments, the first and second lens groups (e.g., the first lens 102 and the second lens 106) are rigidly coupled to the mounting structure 112, and the inner lens element (e.g., inner lens 104) is not rigidly coupled to the mounting structure 112. More particularly, as described herein, the inner lens 104 is moveable along the optic axis relative to the first lens 102 and the second lens 106 in order to focus an image on the digital image sensor 110.

The lens unit 100 includes at least one voice coil (e.g., a voice coil 118). In some embodiments, the voice coil 118 includes a plurality of windings of an electrical conductor, such as copper or aluminum wire. In some embodiments, the voice coil 118 is disposed around the one or more magnetostrictive elements. For example, as shown in FIG. 1, the voice coil 118 is disposed around the magnetostrictive spacer 116. When an electrical voltage or current is applied to the voice coil 118, a magnetic field is produced, the magnitude of which is based on the characteristics of the voltage or current applied to the voice coil 118.

In some embodiments, the lens unit 100 includes a Hall sensor (not shown), wherein the Hall sensor is configured to measure the magnetic field produced by the voice coil 118. The magnitude of the magnetic field correlates to the amount of expansion of the magnetostrictive spacer 116. Accordingly, the characteristics (e.g., the magnitude) of the magnetic field measured by the Hall sensor are used to infer the movement and/or position of the inner lens 104. In some embodiments, the movement and/or position of the inner lens 104 inferred by the Hall sensor are used as feedback for a closed-loop autofocus controller.

In some embodiments, the lens unit 100 includes a current (or voltage) control unit (not pictured), where the current (or voltage) control unit is configured to control the current (or voltage) applied to the voice coil 118. In some embodiments, the current (or voltage) control unit is configured to control the current (or voltage) applied to the voice coil 118 based on magnetic field information provided by the Hall sensor, described above.

FIG. 2A illustrates an axial or “end” view of a portion of a lens actuator unit 200A (or lens unit 200A for short) employing magnetostrictive materials, according to some embodiments. The lens unit 200A includes a plurality of lenses, including a first lens element (e.g., a single first lens 202 as shown, or a lens group that includes a plurality of lenses).

In some embodiments, the lens unit 200A includes focusing mechanisms (not shown) that focus an image on a digital image sensor by moving at least some of the plurality of lenses along an optic axis 222 of the lens unit 200A (e.g., corresponding to the +z direction in FIG. 2A). (The optic axis 222 is an end-on view of the optical axis, and is parallel to the z direction.) In some embodiments, the focusing mechanisms include magnetostrictive elements that move at least some of the plurality of lenses, such as the magnetostrictive spacer 116 described with respect to FIG. 1. In some embodiments, the mechanisms include a voice coil and one or more magnets that are configured to move all of the plurality of lenses to focus the image. Conventional focusing mechanisms are also contemplated.

The lens unit 200A includes a plurality of magnetostrictive elements coupled to the first lens 202 (or, if the first lens element is a lens group, to the lens group). In some embodiments, the one or more magnetostrictive elements are made of an alloy that includes terbium and iron. In some embodiments, the one or more magnetostrictive elements are made of or include Terfenol-D.

The lens unit 200A also includes a plurality of voice coils, where a respective voice coil is configured to strain a corresponding magnetostrictive element in the plurality of magnetostrictive elements coupled to the first lens element. For example, as shown in FIG. 2A, voice coil 204 is configured to generate a magnetic field that induces strain in the magnetostrictive element 214, and voice coil 206 is configured to generate a magnetic field that induces strain in the magnetostrictive element 216.

As shown in FIG. 2A, in some embodiments, the lens unit 200A includes two magnetostrictive elements (and corresponding voice coils) that cause the lens 202 to move. For example, magnetostrictive element 214 is configured to move the first lens 202 in a ±x direction, and magnetostrictive element 216 is configured to move the lens 202 in a ±y direction that is orthogonal to the x direction, where the optic axis 222 is along the z direction.

In some embodiments, opposite to each of the magnetostrictive elements 214 and 216 is a resilient spacer (spacer 218 and spacer 220, respectively) that expands or contracts in concert with the movement of the magnetostrictive elements 214 and 216. For example, the spacer 218 contracts when the magnetostrictive element 214 expands, and the spacer 218 expands when the magnetostrictive element 214 contracts. Similarly, the spacer 220 contracts when the magnetostrictive element 216 expands, and the spacer 220 expands when the magnetostrictive element 216 contracts. In some embodiments, the spacers 218 and 220 are compliant in other directions as well. For example, the spacer 218 will elastically deform in a ±y direction (e.g., a bending deformation) in response to movement of element 216 in a ±y direction, and the spacer 220 will elastically deform in a ±x direction (e.g., a bending deformation) in response to movement of element 214 in a ±x direction.

In some embodiments, a lens actuator unit includes four magnetostrictive elements, where one pair of magnetostrictive elements is configured to move the first lens element in a ±x direction and a second pair of magnetostrictive elements is configured to move the first lens element in a ±y direction that is orthogonal to the ±x direction. FIG. 2K illustrates a portion of a lens actuator unit 200B in accordance with such an embodiment. In addition to magnetostrictive elements 214 and 216 and voice coils 204 and 206, the lens actuator unit 200B includes a magnetostrictive element 240, a corresponding voice coil 242 that is configured to generate a magnetic field that induces strain in the magnetostrictive element 240, a magnetostrictive element 226, and a corresponding voice coil 228 that is configured to generate a magnetic field that induces strain in the magnetostrictive element 226.

In some embodiments, the magnetostrictive elements 216 and 226 (and their corresponding voice coils 206 and 228) are configured to move the lens 202 in a ±y direction, and the magnetostrictive elements 214 and 240 (and their corresponding voice coils 204 and 242) are configured to move the lens 202 in a ±x direction. For example, in order to move the lens 202 in the +x direction, a magnetic field that causes the magnetostrictive element 214 to expand is generated by the voice coil 204, and a magnetic field that causes the magnetostrictive element 240 to contract is generated by the voice coil 242. Similarly, in order to move the lens 202 in the +y direction, a magnetic field that causes the magnetostrictive element 226 to expand is generated by the voice coil 228, and a magnetic field that causes the magnetostrictive element 216 to contract is generated by the voice coil 206. Thus, the lens 202 is movable in both ±x and ±y directions.

In some embodiments, the voice coils are coupled to and/or embedded in a circuit board (e.g., a flexible circuit board) that is oriented in the lens actuator unit such that respective voice coils are in proximity to respective magnetostrictive elements. For example, FIG. 2L illustrates a portion of a lens actuator unit 200C having four magnetostrictive elements (e.g., elements 214, 216, 240, and 226) with a circuit board 230 surrounding the lens 202 and the four magnetostrictive elements. The circuit board 230 includes four voice coils 232, 234, 236, and 238, where each respective voice coil is positioned in proximity to (and configured to control the expansion and/or contraction of) a respective magnetostrictive element 214, 216, 240, or 226.

FIG. 2M illustrates an example of the circuit board 230, where the circuit board 230 is a flexible printed circuit board that is configured to be deformed when incorporated with the lens actuator unit 200C (e.g., the circuit board 230 is wrapped around a portion of the lens actuator unit 200C that includes the magnetostrictive materials). The circuit board 230 is shown in an undeformed configuration in FIG. 2M.

The magnetostrictive elements 214 and 216 (FIG. 2A) or 214, 216, 226, and 240 (FIGS. 2K-L) are coupled to the first lens 202 in any appropriate way. In some embodiments, one or more of the magnetostrictive elements included in the lens unit 200 (e.g., lens unit 200A, FIG. 2A; 200B, FIG. 2K; or 200C, FIG. 2L) are rigidly coupled to the first lens 202 (for example, the magnetostrictive element is glued or bonded to the first lens 202). In some embodiments, one or more of the magnetostrictive elements included in the lens unit 200 are flexibly coupled to the first lens 202.

As described herein, magnetostrictive elements can be used to move a lens in multiple directions. To stabilize the image focused on the digital image sensor, a respective magnetostrictive element moves the first lens 202 away from the optic axis 222 in response to a current applied to a corresponding voice coil for the respective magnetostrictive element. The motion of the first lens 202 may be any appropriate motion for stabilizing the image. In some embodiments, the motion is a “translation” motion that is perpendicular to the optic axis 222 (e.g., in a ±x direction or a ±y direction, or a direction including components in both ±x and ±y directions). In some embodiments, the motion is a “tilt” motion, where the optic axis of the first lens 202 is tilted with respect to the optic axis 222 of the lens unit 200 (e.g., lens unit 200A, FIG. 2A; 200B, FIG. 2K; or 200C, FIG. 2L).

FIGS. 2B-2D illustrate motion of the first lens 202 that is used stabilize an image, according to some embodiments. FIG. 2B illustrates the first lens 202 when the optic axis 224 of the first lens 202 is collinear with the optic axis 222 (e.g., because the first lens 202 has not been moved to compensate for camera shake). FIG. 2C illustrates a translation motion, where the first lens 202 is shifted in the positive x direction (e.g., by the voice coil 204 and corresponding magnetostrictive element 214). FIG. 2D illustrates a tilt motion, where the first lens 202 (and its optic axis 224) is tilted with respect to the optic axis 222.

While FIGS. 2B-2D illustrate several example lens movements, multiple discrete movements may be combined to create compound lens movements. For example, a translation motion may be combined with a tilting motion in order to stabilize an image being focused on an image sensor.

In some embodiments, the magnetostrictive elements of the lens unit 200 (e.g., magnetostrictive elements 214, 216, 226, and/or 240) are configured such that the lenses are in a neutral alignment (i.e., the optic axis of each individual lens is collinear with the optic axis 222) when the magnetostrictive elements are at least partially expanded. Thus, in order to achieve neutral alignment, the magnetostrictive elements must be subjected to a magnetic field. When movement of a lens away from the optical axis is required (either a “tilt” or a “translation” motion, as discussed below), the magnitude of the magnetic field is increased to cause a respective magnetostrictive element to expand further from the partially expanded state, or decreased to cause the respective magnetostrictive element to contract from the partially expanded state.

FIGS. 2E-2J illustrate example configurations of the first lens 202 and the magnetostrictive element 214 to induce motion in two different directions. In particular, FIG. 2E is a partial cross-sectional view of a portion of the first lens 202 and the magnetostrictive element 214, according to some embodiments, where the optic axis 224 of the first lens 202 is collinear with the optic axis 222 (e.g., the lens has not yet been moved in order to stabilize an image). In this embodiment, the magnetostrictive element 214 is configured to expand and contract in the ±x direction, and, due to the angled surfaces of the magnetostrictive element 214 and the first lens 202, expansion of the magnetostrictive element 214 causes the optic axis 224 of the first lens 202 to be tilted in the xz plane in a first direction with respect to the optic axis 222. FIG. 2F illustrates the magnetostrictive element 214 in an expanded state (due to an increase in the magnetic field to which the magnetostrictive element 214 is subjected), and the corresponding tilt of the optic axis 224 of the first lens 202 in the xz plane in the first direction. FIG. 2G illustrates the magnetostrictive element 214 in a less expanded state (due to a decrease in the magnetic field to which the magnetostrictive element 214 is subjected), and the corresponding tilt of the optic axis of the first lens 202 in the xz plane in a second direction opposite to the first direction with respect to the optic axis 222. In some embodiments, the angle of the tilt is adjusted to amplify the stroke.

The angle of the surfaces of the magnetostrictive element 214 and the first lens 202 are configured to achieve the desired amount of tilt of the lens 202 in response to a particular amount of expansion (or contraction) of the magnetostrictive element 214. For example, in FIGS. 2E-2G, the surface of the magnetostrictive element 214 meets the surface of the first lens 202 at approximately a −30 degree angle. By increasing or decreasing this angle, the lens 202 will be caused to tilt more or less in response to a change in size of the magnetostrictive element.

FIG. 2H is a partial cross-sectional view of a portion of the first lens 202 and the magnetostrictive element 214, according to some embodiments. In contrast to the configuration shown and described in FIGS. 2E-2G, which causes a “tilt” motion in response to a change in size of the magnetostrictive element 214, the configuration in FIG. 2H is configured to cause a “translation” motion in response to a change in size of the magnetostrictive element 214. The magnetostrictive element 214 is configured to expand and contract in the ±x direction and cause the first lens 202 to move parallel to the direction of expansion and contraction of the magnetostrictive element 214 (i.e., in the ±x direction).

In FIG. 2H the optic axis 224 of the first lens 202 is collinear with the optic axis 222 (e.g., the lens has not yet been moved in order to stabilize an image). FIG. 2I illustrates the element 214 in an expanded state (due to an increase in the magnetic field to which the element 214 is subjected with respect to FIG. 2H), and the corresponding translation of the first lens 202 in the +x direction. FIG. 2J illustrates the element 214 in a less expanded state (due to a decrease in the magnetic field to which the element 214 is subjected with respect to FIG. 2H), and the corresponding translation of the first lens 202 in the −x direction.

FIGS. 2A-2L illustrate magnetostrictive elements and corresponding voice coils for moving one lens away from the optic axis in order to stabilize an image. In some embodiments, magnetostrictive elements and corresponding voice coils are used to move any number of lenses of a lens actuator. For example, in some embodiments, two or more of the lenses in a lens actuator include magnetostrictive elements and corresponding voice coils for moving the two or more lenses away from the optic axis in order to stabilize an image.

FIG. 3 is a block diagram illustrating an imaging system 300 in accordance with some embodiments. In some embodiments, the imaging system 300 is implemented in a mobile phone (e.g., a smart phone) or other mobile electronic device. The imaging system 300 typically includes one or more processing units (processors or cores) 302, one or more network or other communications interfaces 304, memory 306, and one or more communication buses 307 for interconnecting these components. The communication buses 307 optionally include circuitry (sometimes called a chipset) that interconnects and controls communications between system components. The imaging system 300 optionally includes a user interface 312. In some embodiments, the optional user interface 312 includes a display device 314. In some embodiments, the optional user interface 312 includes inputs such as a keyboard/mouse 318, and/or other input mechanisms. Alternatively or in addition, in some embodiments, the display device 314 includes a touch-sensitive surface 316, in which case the display device 314 is a touch-sensitive display. In devices that have a touch-sensitive display, a physical keyboard is optional (e.g., a soft keyboard may be displayed when keyboard entry is needed). The optional user interface 312 also includes an audio output device 320, such as speakers or an audio output connection connected to speakers, earphones, or headphones. In some embodiments, the optional user interface 312 includes an audio input device 322 (e.g., a microphone) to capture audio (e.g., speech from a user).

The imaging system 300 also includes an image/video capture device 308, such as a camera or webcam. The image/video capture device 308 includes a lens actuator unit as described herein (e.g., a lens actuator unit 100, a lens actuator unit 200, or a lens actuator unit that includes any combination of the features described with respect to the lens actuator units 100 and 200). In some embodiments, the image/video capture device 308 includes a digital image sensor (e.g., the digital image sensor 108).

In some embodiments, the imaging system 300 includes one or more motion sensor(s) 310, such as gyroscopes and/or accelerometers, for detecting motion of the imaging system 300, and/or a lens assembly associated with or coupled to the imaging system.

Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the processor(s) 302. Memory 306, or alternately the non-volatile memory device(s) within memory 306, includes a non-transitory computer readable storage medium. In some embodiments, memory 306 or the computer readable storage medium of memory 306 stores the following programs, modules and data structures, or a subset or superset thereof:
an operating system 324 that includes procedures for handling various basic system services and for performing hardware dependent tasks;
a communications module 326 that is used for connecting the imaging system 300 to other computers via the one or more communication interface(s) 304 (wired or wireless) and one or more communication networks, such as the Internet, cellular telephone networks, mobile data networks, other wide area networks, local area networks, metropolitan area networks, and so on;
a motion sensor module 326 for receiving data from the one or more motion sensors 310, for calculating motion, position, and/or orientation information from the data received from the one or more motion sensors 310, and for providing the motion, position, and/or orientation information to other modules, such as the autofocus module 330 and/or the optical image stabilization module 332;
an image/video capture module 328 (e.g., a camera module) for processing a respective image or video captured by the image/video capture device 308 (and/or the digital image sensor of the image/video capture device 308), where the image/video capture module 328 includes the following modules (or sets of instructions), or a subset or superset thereof:
   an autofocus module 330 for focusing an image on a digital image sensor image/video capture device 308, for example, by adjusting the position of one or more lenses in a lens actuator unit, where adjusting the position of the one or more lenses is performed by controlling the current and/or voltage applied to one or more voice coils in a lens actuator unit based on lens position information (e.g., from a Hall sensor) and/or image focus information (e.g., from the digital image sensor); and
   an optical image stabilization module 332 for stabilizing an image on a digital image sensor image/video capture device 308, for example, by adjusting the position of one or more lenses in a lens actuator unit, where adjusting the position of the one or more lenses is performed by controlling the current and/or voltage applied to one or more voice coils in a lens actuator unit based on motion and/or position information of the imaging system 300 (e.g., from the motion sensor(s) 310 and/or the motion sensor module 326).

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 306 stores a subset of the modules and data structures identified above. Furthermore, memory 306 optionally stores additional modules and data structures not described above.

Attention is now directed towards FIG. 4, which is a flow diagram illustrating a method 400 of focusing an image in accordance with some embodiments. FIG. 4 corresponds to instructions stored in a computer memory or computer readable storage medium (e.g., memory 306).

In some embodiments, the method 400 is performed on an imaging system (e.g., imaging system 300). The imaging system includes a camera lens actuator unit (e.g., lens actuator unit 100) that includes a first lens group that includes at least one lens (e.g., first lens 102), a second lens group that includes at least one lens (e.g., second lens 106), and an inner lens element (e.g., inner lens 104 or an inner lens group) configured to move along an optic axis between the first lens group and the second lens group (e.g., inner lens 104). FIG. 1 and the related discussion include additional details of the lens actuator unit 100.

The camera lens actuator unit also includes one or more magnetostrictive elements (e.g., magnetostrictive spacer 116) coupled to the inner lens element, and at least one voice coil actuator (e.g., voice coil 118). In some embodiments, the voice coil actuator is disposed around the one or more magnetostrictive elements.

As described above, in some embodiments, the one or more magnetostrictive elements are made of an alloy that includes terbium and iron. In some embodiments, the one or more magnetostrictive elements are made of Terfenol-D.

The imaging system 300 applies a current (or voltage) to the at least one voice coil actuator (402). In response to applying the current (or voltage) to the at least one voice coil actuator, the one or more magnetostrictive elements move the inner lens element along an optic axis to focus the image on a digital image sensor (404).

For example, the image/video capture module 328 determines whether an image detected by a digital image sensor is in focus. In some embodiments, the imaging system 300 uses contrast detection autofocus techniques and systems to determine whether an image detected by a digital image sensor is in focus. In some embodiments, the imaging system 300 uses phase detection autofocus techniques and systems to determine whether an image detected by a digital image sensor is in focus. If the image is not in focus, the autofocus module 330 applies a current (or voltage) to the at least one voice coil actuator (at 402) in order to cause the inner lens element with the one or more magnetostrictive elements to move along an optic axis to focus the image on a digital image sensor (at 404). In some embodiments, applying the current (or voltage) to the at least one voice coil actuator includes increasing the current (or voltage) applied to the at least one voice coil actuator. In some embodiments, applying the current (or voltage) to the at least one voice coil actuator includes decreasing the current (or voltage) applied to the at least one voice coil actuator.

In some embodiments, the imaging system 300 measures a magnetic field produced by the at least one voice coil actuator with a Hall sensor (406).

In some embodiments, the imaging system 300 controls, with a current (or voltage) control unit, the current (or voltage) applied to the at least one voice coil actuator based on magnetic field information provided by the Hall sensor (408).

As noted above, the magnetic field produced by the at least one voice coil actuator (and detected by the Hall sensor) provides information from which the position of the inner lens element can be determined. Additionally, the digital image sensor (and/or other autofocus components) can calculate a target position of the inner lens element that will result in the image being in-focus. Using a current position of the inner lens element (as determined based on magnetic field information provided by the Hall sensor) and a calculated target position of the lens, the imaging system 300 controls the current (or voltage) applied to the at least one voice coil actuator (at 402) to focus the image on the digital image sensor by moving the inner lens element directly to the calculated target position that results in a focused image. In some embodiments, moving the inner lens element directly to the calculated target position reduces or eliminates the need to “hunt” for the proper image focus by oscillating around and converging on the lens position that corresponds to a focused image.

Attention is now directed towards FIG. 5, which is a flow diagram illustrating a method 500 of stabilizing an image in accordance with some embodiments. FIG. 5 corresponds to instructions stored in a computer memory or computer readable storage medium (e.g., memory 306).

In some embodiments, the method 500 is performed on an imaging system (e.g., imaging system 300). The imaging system includes a camera lens actuator unit (e.g., lens actuator unit 200) that includes a plurality of lenses, including a first lens element (e.g., first lens 202). FIGS. 2A-2J, and the related text, provide additional details of the lens actuator unit 200 (e.g., lens unit 200A, FIG. 2A; 200B, FIG. 2K; or 200C, FIG. 2L).

The camera lens actuator unit also includes a plurality of magnetostrictive elements (e.g., magnetostrictive elements 214, 216) coupled to the first lens element, and a plurality of voice coils (e.g., voice coils 204, 206). As described above, in some embodiments, the one or more magnetostrictive elements are made of an alloy that includes terbium and iron. In some embodiments, the one or more magnetostrictive elements are made of Terfenol-D.

A respective voice coil is configured to strain a corresponding magnetostrictive element in the plurality of magnetostrictive elements coupled to the first lens element. As described above, in some embodiments, the strain in the corresponding magnetostrictive element causes movement of the first lens element (e.g., a “tilt” or a “translation” movement).

The imaging system 300 focuses an image on a digital image sensor by moving at least some of the plurality of lenses along an optic axis of the camera lens actuator unit (502). In some embodiments, the imaging system 300 focuses the image on the digital image sensor using autofocus systems and methods such as those shown described with respect to FIGS. 1, 3, and 4. In some embodiments, conventional autofocus systems and methods are used instead of or in addition to those described herein.

The imaging system 300 stabilizes the image by moving, with a respective magnetostrictive element, the first lens element away from the optic axis in response to a current applied to a corresponding voice coil for the respective magnetostrictive element (504). In some embodiments, moving the first lens element away from the optic axis corresponds to a tilt motion (e.g., as shown and described above with respect to FIGS. 2D-G). In some embodiments, moving the first lens element away from the optic axis corresponds to a translation motion (e.g., as shown and described above with respect to FIGS. 2C and 2H-J). In some embodiments, moving the first lens element away from the optic axis corresponds to a combination of a tilt and a translation motion (or any other appropriate movements).

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

In the foregoing description, any discussion relating to a lens applies equally to both single lenses and lens groups. For example, where a magnetostrictive element is described in the foregoing discussion as being coupled to a single lens in an imaging lens, it could also be coupled to multiple lenses (e.g., a compound lens, or a lens group containing multiple lenses), depending on the particular arrangement of the lenses in the imaging lens.

What is claimed is:

1. A camera lens actuator unit, comprising:
a first lens group that includes at least one lens;
a second lens group that includes at least one lens;
an inner lens element configured to move along an optic axis between the first lens group and the second lens group, to focus an image on a digital sensor;
at least one voice coil; and
one or more magnetostrictive elements coupled to the inner lens element, to move the inner lens element along the optic axis in response to a current applied to the at least one voice coil.

2. The camera lens actuator unit of claim 1, further comprising:
a Hall sensor to measure a magnetic field produced by the at least one voice coil; and
a current control unit to control the current applied to the at least one voice coil based on magnetic field information provided by the Hall sensor.

3. The camera lens actuator unit of claim 1, wherein the one or more magnetostrictive elements comprise an alloy that includes terbium and iron.

4. The camera lens actuator unit of claim 1, wherein the inner lens element comprises a single inner lens.

5. The camera lens actuator unit of claim 1, wherein the inner lens element comprises a group of at least two lenses.

6. A method, comprising:
at a camera lens actuator unit having
a first lens group that includes at least one lens,
a second lens group that includes at least one lens,
an inner lens element configured to move along an optic axis between the first lens group and the second lens group,
one or more magnetostrictive elements coupled to the inner lens element, and
at least one voice coil actuator:
applying a current to the at least one voice coil actuator; and,
in response to applying the current to the at least one voice coil actuator, moving the inner lens element with the one or more magnetostrictive elements along an optic axis to focus an image on a digital image sensor.

7. The method of claim 6, including:
measuring a magnetic field produced by the at least one voice coil actuator with a Hall sensor; and
controlling, with a current control unit, the current applied to the at least one voice coil actuator based on magnetic field information provided by the Hall sensor.

8. The method of claim 6, wherein the one or more magnetostrictive elements comprise an alloy that includes terbium and iron.

9. A mobile electronic device comprising an imaging system, the imaging system comprising:
a first lens group that includes at least one lens;
a second lens group that includes at least one lens;
an inner lens element configured to move along an optic axis between the first lens group and the second lens group, to focus an image on a digital sensor;
at least one voice coil; and
one or more magnetostrictive elements coupled to the inner lens element, to move the inner lens element along the optic axis in response to a current applied to the at least one voice coil.

10. The mobile electronic device of claim 9, wherein the imaging system further comprises:
a Hall sensor to measure a magnetic field produced by the at least one voice coil; and
a current control unit to control the current applied to the at least one voice coil based on magnetic field information provided by the Hall sensor.

11. The mobile electronic device of claim 9, wherein the inner lens element comprises a single inner lens.

12. The mobile electronic device of claim 9, wherein the inner lens element comprises a group of at least two lenses.

13. A camera lens actuator unit, comprising:
a plurality of lenses including a first lens element, at least some of the plurality of lenses being moveable along an optic axis of the camera lens actuator unit to focus an image on a digital image sensor;
a plurality of magnetostrictive elements coupled to the first lens element; and
a plurality of voice coils to strain respective magnetostrictive elements of the plurality of magnetostrictive elements;
wherein, to stabilize the image, a respective magnetostrictive element is to move the first lens element away from the optic axis of the camera lens actuator unit in response to a current applied to a corresponding voice coil for the respective magnetostrictive element.

14. The camera lens actuator unit of claim 13, wherein the plurality of magnetostrictive elements comprise an alloy that includes terbium and iron.

15. The camera lens actuator unit of claim 13, wherein the first lens element comprises a single lens.

16. The camera lens actuator unit of claim 13, wherein the first lens element comprises a group of at least two lenses.

17. A method, comprising:
at a camera lens actuator unit having
a plurality of lenses, including a first lens element,
a plurality of magnetostrictive elements coupled to the first lens element, and
a plurality of voice coils, wherein a respective voice coil is configured to strain a corresponding magnetostrictive element in the plurality of magnetostrictive elements coupled to the first lens element:
focusing an image on a digital image sensor, the focusing comprising moving at least some of the plurality of lenses along an optic axis of the camera lens actuator unit; and
stabilizing the image, the stabilizing comprising moving, with a respective magnetostrictive element, the first lens element away from the optic axis in response to a current applied to a corresponding voice coil for the respective magnetostrictive element.

18. The method of claim 17, wherein the one or more magnetostrictive elements comprise an alloy that includes terbium and iron.

19. A mobile electronic device comprising an imaging system, the imaging system comprising:
a plurality of lenses including a first lens element, at least some of the plurality of lenses being moveable along an optic axis of the camera lens actuator unit to focus an image on a digital image sensor;
a plurality of magnetostrictive elements coupled to the first lens element; and
a plurality of voice coils to strain respective magnetostrictive elements of the plurality of magnetostrictive elements;
wherein, to stabilize the image, a respective magnetostrictive element is to move the first lens element away from the optic axis of the camera lens actuator unit in response to a current applied to a corresponding voice coil for the respective magnetostrictive element.

20. The mobile electronic device of claim 19, wherein the first lens element comprises a single lens.

21. The mobile electronic device of claim 19, wherein the first lens element comprises a group of at least two lenses.
